(19) United States
(12) Patent Application Publication
(10) Pub. No.: US 2003/0200543 A1
(43) Pub. Date: Oct. 23, 2003

(54) Audience response management system

(76) Inventor: Jeffrey D. Burns, Phoenixville, PA (US)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/125,040

(22) Filed: Apr. 18, 2002

(51) Int. Cl. H04N 7/16; H04H 9/00; G09G 5/00

(52) U.S. Cl. 725/16; 345/744; 345/745; 345/747; 725/9

(57) ABSTRACT

An audience response management system including a computer software program utilized to collect, analyze, summarize, present and distribute responses, evaluations, opinions and votes from an audience using audience response hardware. The software allows configuration of the appearance and behavior of the polling system, testing of the connections to audience response hardware (required as the source of the polling data), organizing of multiple sets of data into user-defined groups of presentations, and exporting and printing of data in its raw form or in any of a selection of desired compiled formats for the purposes of further analyzing and presenting the data.

### COMPUTER PROGRAM LISTING APPENDIX

Appended hereto is a duplicate pair of compact discs which each contain a computer program listing of an audience response/polling management software program. The disclosure provided by the computer program listing on the compact discs is incorporated herein by reference.

1. Field of the Invention

The present invention relates to a method and system for polling an assembled group of people with questions and suggested answers thereto to ascertain the consensus of the audience with regard to a particular topic, and more particularly, the present invention relates to computer software which interfaces with existing audience response technology, which configures the appearance and behavior of the polling system, which tests the connections to the audience response devices and which collects, analyzes, summarizes, and presents the votes of the audience.

1. Background of the Invention

Examples of audience polling systems are disclosed by U.S. Pat. Nos.: 5,273,437 issued to Caldwell et al.; 4,377,870 issued to Anderson et al.; and 5,226,177 issued to Nickerson. All these systems include means for presenting questions to the audience, means for collecting answers or votes from each member of the audience, and means for reporting the polling results.

Typically, questions are asked by a live speaker and/or are displayed on a monitor or other projection device through the use of presentation computer software, a pre-recorded video, overheads or the like. The audience responds to the questions via remote control keypad units or the like which communicate via hard wire or other non-hard wire communication systems to a central processor or like hardware. The computer processor performs statistical and/or other analysis and presents the polling results on a monitor. For example, the '177 patent discloses displaying the polling results in real-time as an overlay on the original display shown to the audience.

Computers and computer software technology have advanced significantly since the above referenced patents issued. Thus, the above referenced patents are no longer state of the art with respect to the use of the stated computers and/or computer software disclosed therein. More recently, computer software is utilized to substantially manage and control the entire polling system. The polling software typically performs multiple functions including system setup and configuration, presentation setup and editing, polling, and data maintenance, exporting and printing.

Known polling software products are intended to function as stand-alone products that typically do not interface with the means for providing the presentation to the audience, such as, presentation computer software or the like. Thus, the polling software product inherently requires the user to tailor the appearance and behavior of the design of the polling presentation according to the limited features provided by the respective polling software product. For instance, such polling software products require the specific prompt for polling to be represented by the polling software in some tangible form which is typically in the form of prompts provided as multiple choice questions, true/false or yes/no questions, rating questions, and/or the like. This places limitations on the presenter whose presentation often includes audience response prompts that are not readily capable of being represented in the aforementioned polling software formats.

Further, since the aforementioned polling software products require the text of the questions to exist in the polling software itself, there is a redundancy in that the questions posed to the audience are required to exist in the presentation software, or other means utilized to present the questions, and in the polling software. This redundancy complicates and increases the amount of preparation required to place the polling software into a condition to begin the desired polling task.

An example of the functioning of a prior art polling software is illustrated by the flowchart diagrams of FIGS. 1 and 2 of the present application. The prior art polling software 10 is generally presented as a sequence of steps. The steps generally include configuring and preparing the system to either collect new audience response information, review previously-collected audience response information, and/or distribute or disseminate previously-collected audience response information.

Through a series of passes through the various sequence of steps represented in FIGS. 1 and 2, the operator is able to completely prepare for a presentation involving one or more audience response polls. Each sub-process represented in the figure is—as further represented by the flow of logic in the diagram—meant to co-exist with the presentation development process such that any one process can be executed one or more times to arrive at a fully-prepared presentation. Specifically, the operator will proceed through: (a) checking the hardware connection in steps 12, 14, 16, and 18; (b) configuring the appearance and/or behavior of the polling presentation system in steps 20, 22 and 24; (c) creating a new presentation or editing an existing presentation in steps 26, 28, 30 and 32; (d) proceeding through the presentation by polling the audience in steps 34, 36, 38, 40, 42 and 44; (e) reviewing any combination of collected results in various displays in steps 46, 48, 50, 52, 54, 56 and 58; (f) creating any of a multitude of semi-customizable reports on the collected data in steps 60, 62, 64 and 66; (g) exporting any of a multitude of prepared formats of the data for analysis and/or presentation in third-party applications in steps 68, 70, 72 and 74; and (h) eliciting, in an ad-hoc, as-needed basis, the assistance of any provided computerized help files or reference materials represented in the software in steps 76, 78, 80, 82, 84 and 86.

The three most crucial areas represented in the prior art diagrams are (1) the process including the creation and/or editing of presentations within the audience polling software itself for later use during a polling process, (2) the relatively large number of steps required to be taken by the operator before any polling task can be commenced, and (3) the presence of the prompt (ie., step 36) referenced by the audience which serves to guide the polling toward the intended scope.

While the aforementioned patents and discussed prior art polling software product may be satisfactory for their intended purposes, there is a need for an improved polling software product which can generically handle audience response polling such that the process of prompting remains exclusively removed and insulated from the polling software product and thereby leaves no restrictions on the presenter for properly representing the desired stimuli intended to elicit a response from the audience. Since the restriction of preparing a prompt using the audience response software is eliminated, the path to completing an audience response poll should be greatly simplified. Thus, the amount of user intervention and preparation time should be significantly reduced relative to the prior art polling software to achieve a desired polling task. Further, preferably the data collected by the polling software should be capable of being presented in real time in a manner that works in concert with a multitude of existing, third-party presentation systems.

### Objects of the Invention

With the foregoing in mind, a primary object of the present invention is to provide an audience response system and method which utilizes polling software that functions without having to prompt the audience with questions and the like thereby permitting the monitoring and display of results of audience response polling to coexist with external stimuli commonly in the form of third-party presentation software.

Another object of the present invention is to provide an audience response system and method which provides a reduction in the preparation time and the number of steps required to achieve the collection of at least one distinct set of data to be treated as an audience response poll for the purposes of subsequent analysis or review.

A further object of the present invention is to provide an improved audience response system and method utilizing polling software which can be readily and efficiently manufactured and marketed.

A still further object of the present invention is to provide an audience response system and method utilizing polling software which can be easily installed and operated on any standard personal computer, or like apparatus, owned and/or operated by various licensees.

Yet a further object of the present invention is to provide an audience response system and method utilizing polling software which can be manufactured at a minimum of expense with regard to both materials and labor, and which accordingly can then be sold to consumers at low prices of sale, thereby making the polling software economically available to the buying public.

Yet still a further object of the present invention is to provide an audience response system and method utilizing polling software which can provide the advantages of the prior art systems, while simultaneously overcoming the disadvantages normally associated therewith.

### SUMMARY OF THE INVENTION

More specifically, the present invention provides a method for polling an audience to determine the consensus response of the audience to a given stimulus. A polling software program which is loaded in a computer provides an interface with a plurality of external audience response hardware devices to facilitate the flow of response data from the external audience response hardware devices into the computer so that the response data can be collected and interpreted by the polling software program. The polling software program collects, analyzes, and summarizes the response data without ever specifically prompting the audience with questions for their response. The polling software program is also utilized to configure the appearance and behavior of a real-time representation of the collected response data to an intended viewer.

Preferably, a presentation means is utilized to present questions and other stimuli to the audience to seek responses from the audience. The stimuli presentation means is separate and distinct from the polling software program and can be provided as a separate presentation software program loaded in the computer. Preferably the polling software program co-exists with the stimuli presentation means so that response data can be collected by the polling software program without the polling software program itself having to prompt the audience with questions and without requiring the stimuli to be represented in some form within the polling software program.

Preferably, the polling software program automatically detects and configures the interface with the external audience response hardware devices to accommodate immediate polling without requiring any intervention by an operator. In addition, preferably the display of the real-time representation of the response data is continually updated automatically by the polling software program without requiring intervention by an operator. Still further, preferably the real-time representation of the response data is provided as an overlay on a corresponding display of the stimuli utilized to prompt the audience's response.

According to other aspects of the present invention, an audience response system and an audience response/polling management software program is provided.

### BRIEF DESCRIPTION OF THE DRAWINGS

The foregoing and other objects, features and advantages of the present invention should become apparent from the following description when taken in conjunction with the accompanying drawings, in which:

FIG. 1 is a flowchart diagram depicting the existing processes for operating an audience response system according to the principles of the prior art;

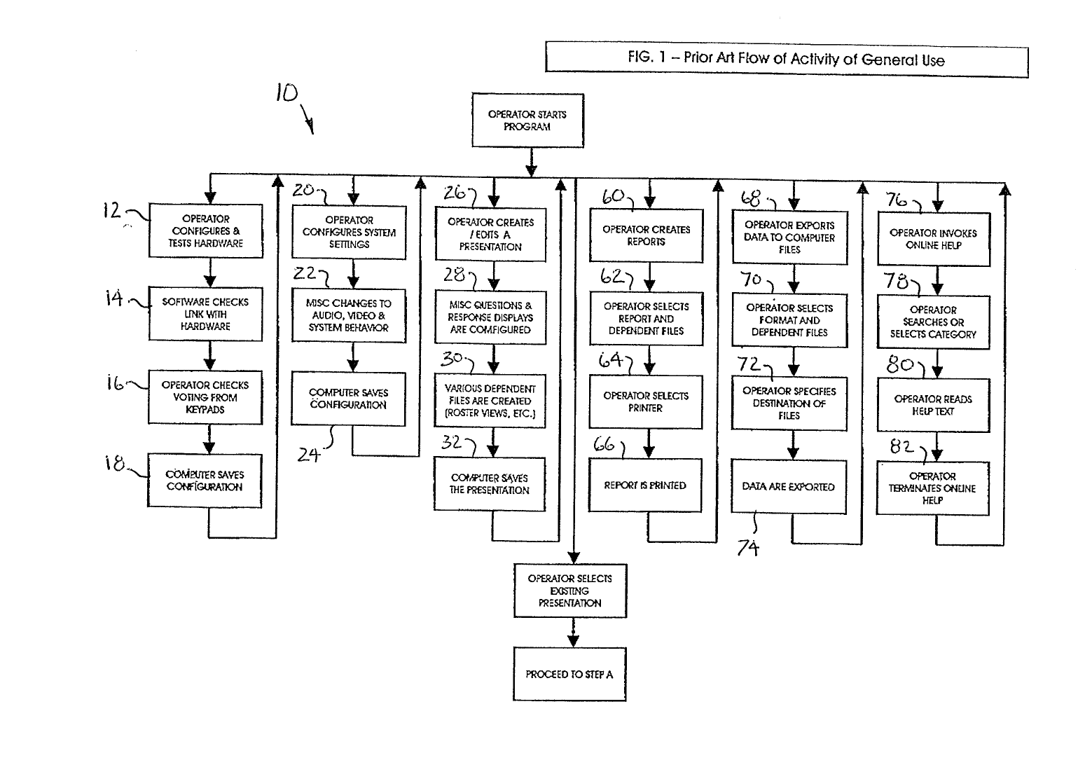

FIG. 2 is a continuation of the flowchart diagram depicting the existing processes for operating an audience response system according to the principles of the prior art;

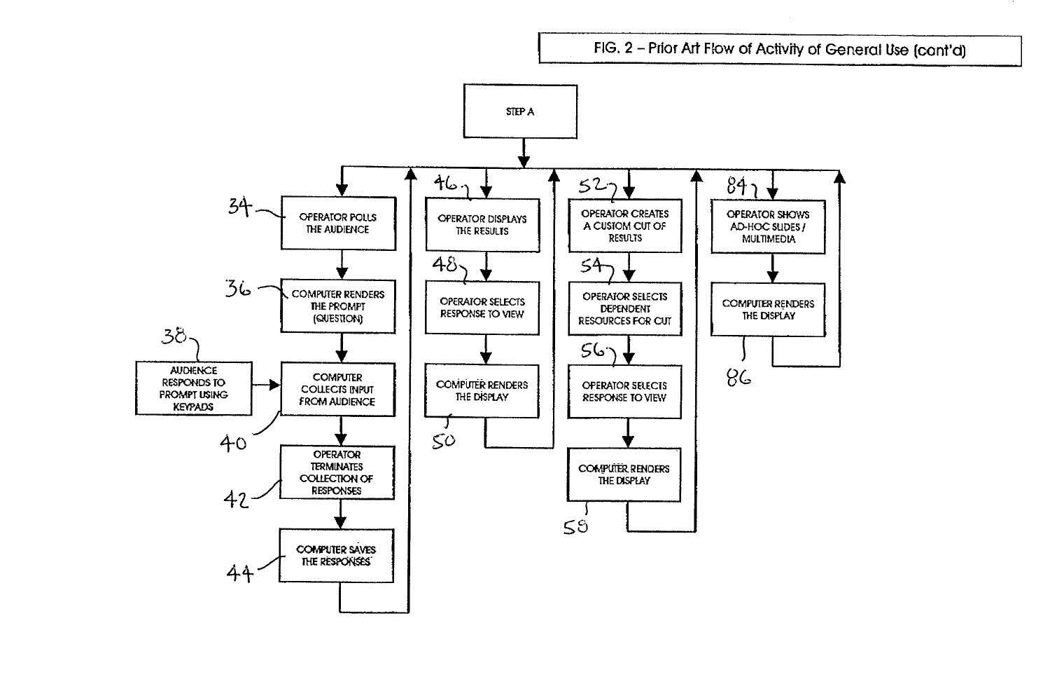

FIG. 3 is a flowchart diagram depicting the processes for operating an audience response system according to the principles of the present invention; and

FIG. 4 is a continuation of the flowchart diagram depicting the processes for operating an audience response system according to the principles of the present invention.

### DETAILED DESCRIPTION OF THE PREFERRED EMBODIMENT

The present invention relates to an audience polling system and method for presenting questions to an audience, for collecting answers or votes from each member of the audience, and for displaying/reporting the polling results. The system and method seek to achieve similar, but improved, results as that disclosed by U.S. Pat. Nos.: 5,273,437 issued to Caldwell et al.; 4,377,870 issued to Anderson et al.; and 5,226,177 issued to Nickerson. The disclosures provided by the three above referenced patents are incorporated herein by reference.

Preferably, questions are posed to the audience via any existing third party presentation software. To this end, the desired stimuli is displayed by the presentation software via a monitor viewable by the audience. Thus, each question and each possible set of answers thereof are prepared utilizing the presentation software and are presented to the audience solely by the presentation software. A sequence of questions can be provided to the audience by a live presenter or operator manually controlling the progress of the presentation via the presentation software, or the progress can be controlled automatically by the presentation software, for instance, by pre-set time intervals between questions, or like mechanism.

Of course, other means of presenting sets of questions and answers can be utilized. For instance, the set of questions and answers can be posed by a live speaker or be displayed on a monitor or other projection device through the use of a pre-recorded video, overheads or the like.

The audience responds to the questions via remote control keypad units or like devices. Typically, the keypad units are hardwired into a computer so that the data entered by the audience can be collected by polling software within the computer. As alternatively disclosed in the above referenced patents, the keypad units can be provided as portable hand-held units which communicate via radio waves or the like.

The novel aspect of the audience response system and method of the present invention relates to the software loaded in the computer which manages the polling operation. As will be discussed in detail below, the polling software readily interfaces with existing audience response technology, readily configures the appearance and behavior of the polling system, readily tests the connections to the audience response devices, and readily collects, analyzes, summarizes, and presents the votes of the audience.

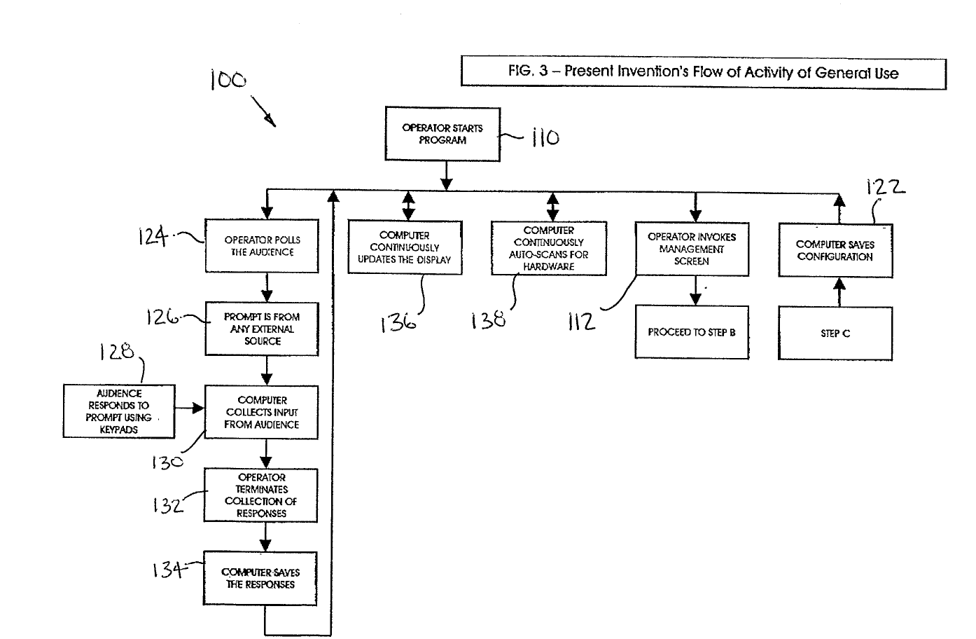

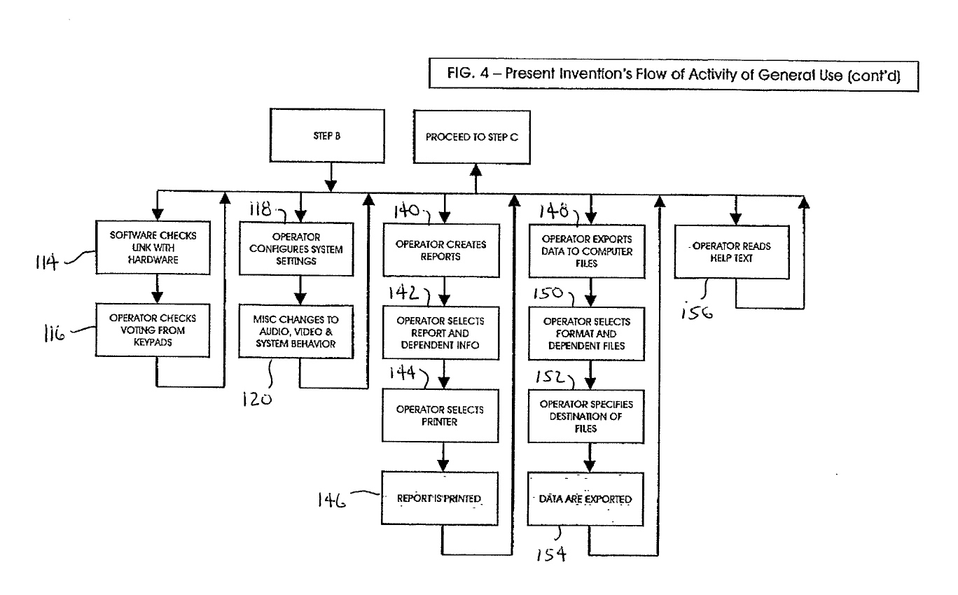

The polling software 100 of the present invention is illustrated by the flowchart diagrams of FIGS. 3 and 4 which present a sequence of steps. The steps generally include configuring the system to either collect new audience response information, review previously-collected audience response information, and/or distribute or disseminate previously-collected audience response information. Through a series of passes through the various sequence of steps represented in FIGS. 3 and 4, the operator is able to accomplish one or more audience response polls.

More specifically, the operator may proceed by starting the program in step 110 and by invoking a management screen in step 112. Thereafter, the operator can check the link with the hardware (ie., voting keypad units) and voting from keypads in steps 114 and 116, can configure the appearance and/or behavior of the polling system in steps 118 and 120, and can save the configuration in step 122. The operator can proceed to poll the audience in steps 124, 126, 128, 130, 132 and 134. Notably, the question/answers prompt is delivered to the audience by an external source in step 126, such as third party presentation software, and not by the polling software 100 itself. The polling software 100 automatically collects the results in step 130 and automatically and continuously updates a display of the results in real-time in step 136. In addition, the polling software 100 automatically and continuously scans for hardware in step 138. Reports are created and printed in steps 140, 142, 144 and 146, and exported in any of a multitude of formats for analysis and/or presentation in third-party applications in steps 148, 150, 152 and 154. Computerized help files can be accessed in step 156.

Thus, the polling software 100 of the present invention manages the audience response information received from unspecified prompts and readily interfaces with technology consistent with the industry for transmission of each person's responses so that the software can collect, manipulate, store, present, distribute and disseminate such information on-demand.

The polling software 100 provides three distinct advantages over the prior art systems. These include: (1) the elimination of the need to create a formal presentation for the purposes of presenting content from the audience response/polling software intended to direct the scope of polling during any one poll of the audience; (2) a reduction in the number of stages/steps required to achieve the fundamental outcome, namely the collection of at least one distinct set of data to be treated as an audience response poll for the purposes of subsequent analysis or review; and (3) the insulation of a prompt from the audience response software, permitting the monitoring and results of audience response polling to co-exist with external stimuli commonly in the form of third-party presentation software.

As stated previously, the prior art systems require the creation of a presentation before any potential to proceed to a polling process where collection of data is intended for storage and later recall. This has been solved by the present invention which completely eliminates this task. This solution provides the operator with a number of bonuses not previously realized. Specifically, a substantial reduction in the amount of preparation time required to initiate a meaningful poll of the audience is realized. In addition, the overhead involved to create and maintain on-going and/or ad-hoc questions and prompts has been eliminated. Such on-going and/or ad-hoc questions and prompts are typically required due to changes in the intended presentation as they are made apparent to the presenter while the selected presentation is currently in progress.

As also stated previously, the prior art systems require a relatively large number of steps to complete an audience response poll and require specific steps to be taken before any potential to proceed to a polling process. In the present invention, this has been solved by eliminating the need for such steps. The eliminated steps include, but are not limited to, the creation of a presentation to which all polling will be directed for scope and the configuration of hardware interface connections to the software which facilitates the proper flow of information collected from the audience response hardware such that the system is capable of properly handling the incoming data to accommodate all future needs during a subsequent presentation. The polling software 100 automatically detects and configures the connected interface to accommodate immediate polling without requiring any intervention on the part of the operator to accomplish the goals of general use. While arriving at the same ultimate goal of proper information flow in this case, the noted difference remains part of the overall solution as a reduction of steps from program start to full operation—defined here as the ability to take an audience poll where the intention is to save the data for later recall and full incorporation into a presentation.

As also stated previously, the prior art systems require the polling software to provide a prompt to the audience to direct the audience to provide a response within a given range of responses. This was accomplished since the creator of the presentation was required to enter the text of the actual prompt (usually in the form of a multiple choice question) into the polling software which formed a standard part of the presentation. In contrast, the present invention eliminates this task and permits the creator of the presentation to utilize any form of external stimuli, including but not limited to third-party presentation software, which normally is found to exist in a format ready for presentation before the creator needs to consider the use of the audience response system.

According to another aspect of the present invention, step 136 of the polling software 100 provides an on-screen representation of audience response data. Preferably, the format of the on-screen representation does not contain specific references to the external stimuli, but rather, co-exists on the screen real-estate of a monitor as an overlay- or inset-type presentation which is viewable only by an intended audience. The size, position and general appearance of the inset is fully customizable by the operator in step 120 to accommodate the needs of the final display's design. Further, the inset display can be tailored to cover the entire display screen at the direction of the operator for any such need. Alternatively, the representation can be configured such that it does not need to co-exist with any form of external stimuli represented as computer software, nor any other form of implied tangible or intangible external stimuli.

The design of the representation of the audience response polling in the form of an overlay according to the present invention substantially departs from the conventional concepts and designs of the prior art, and in so doing provides a modular solution primarily intended to permit the presenter (and all manner of users) to incorporate audience response polling into a presentation leveraging existing, pre-prepared presentations and all manner of external prompting. Thus, the polling software 100 of the present invention further limits redundancy of effort and permits quick set up and initiation of the polling task.

It is to be understood that the invention is not limited in its application to the details of collecting opinions or votes from an audience of any particular size or category or for any specified purpose or industry. The invention is capable of other embodiments and of being practiced and carried out in various ways. Also, it is to be understood that the phraseology and terminology employed herein are for the purpose of description and should not be regarded as limiting.

With respect to the above description, it is to be realized that the optimum procedural relationships for the methods and systems of the invention, to include variations in sequence of steps and manner of operation, and specific application of use, are deemed readily apparent and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact production and operation shown and described, and accordingly, all suitable modifications and equivalents may be resorted to, falling within the scope of the invention.

While a preferred method and system have been described in detail, various modifications, alterations, and changes may be made without departing from the spirit and scope of the method and system according to the present invention as defined in the appended claims.

1. A method for polling an audience to determine the consensus response of the audience to a given stimulus, comprising the steps of:
utilizing a polling software program which is loaded in a computer to provide an interface with a plurality of external audience response hardware devices to facilitate the flow of response data from the external audience response hardware devices into the computer so that the response data can be collected and interpreted by the polling software program;
utilizing said polling software program to collect, analyze, and summarize the response data which is received without being prompted by said polling software program; and
utilizing said polling software program to configure the appearance and behavior of a real-time representation of the response data to an intended viewer.

2. A method according to claim 1, further comprising the step of prompting the audience to respond to questions with means for presenting stimuli to the audience, wherein said means is separate and distinct from said polling software program, and wherein said polling software program co-exists with said means to collect response data such that said polling software program collects the response data without itself having to prompt the audience for the response data and without having the stimuli represented in a form in the polling software program.

3. A method according to claim 1, wherein said polling software program automatically detects and configures the interface with the external audience response hardware devices to accommodate immediate polling without requiring any intervention by an operator.

4. A method according to claim 1, wherein said real-time representation is continually and automatically updated by said polling software program without requiring intervention by an operator.

5. A method according to claim 2, wherein said polling software program automatically detects and configures the interface with the external audience response hardware devices to accommodate immediate polling without requiring any intervention by an operator.

6. A method according to claim 5, wherein said real-time representation is continually and automatically updated by said polling software program without requiring intervention by an operator.

7. A method according to claim 2, wherein said means for presenting stimuli is a separate presentation software program loaded in the computer.

8. A method according to claim 2, wherein said real-time representation of the response data is provided as an overlay on a corresponding display of the stimuli utilized to prompt the audience's response.

9. A method according to claim 1, wherein said external audience response hardware devices are keypad units which have communication links to the computer.

10. In an audience response system having a means for presenting stimuli to an audience for purposes of prompting responses therefrom via a plurality of audience response hardware devices linked to a computer, wherein the improvement comprising:
an audience response/polling management software program which is loaded in said computer and which is separate and distinct from said stimuli presentation means;
said audience response/polling management software program providing an interface with said audience response hardware devices to facilitate the flow of response data from the audience response hardware devices into the computer so that the response data can be collected and interpreted by said audience response/polling management software program;
said audience response/polling management software program providing response data collection, analyzing, and summarizing functions, the response data collected by said audience response/polling management software program being received without being prompted for by said audience response/polling management software program; and
said audience response/polling management software program providing a real-time representation of the response data to an intended viewer and permitting a configuration, appearance and behavior thereof to be modified.

11. An audience response system according to claim 10, wherein said audience response/polling management software program automatically detects and configures the interface with the audience response hardware devices to accommodate immediate polling without requiring any intervention by an operator.

12. An audience response system according to claim 11, wherein said means for presenting stimuli is utilized to prompt the audience to respond to questions, and wherein said audience response/polling management software program co-exists with said means to collect response data such that said audience response/polling management software program collects the response data without itself having to prompt the audience for the response data and without having the stimuli represented in a form in said audience response/polling management software program.

13. An audience response system according to claim 12, wherein said means for presenting stimuli is a separate presentation software program loaded in the computer.

14. An audience response system according to claim 12, wherein said real-time representation of the response data is provided as an overlay on a corresponding di splay of the stimuli utilized to prompt the audience's response.

15. An audience response system according to claim 14, wherein said real-time representation is continually and automatically updated by said audience response/polling management software program without requiring intervention by an operator.

16. An audience response system according to claim 12, wherein said audience response hardware device s are keypad units.

17. In an audience response/polling management software program for use in polling an audience to determine the consensus response of the audience to a given stimulus, wherein the improvement comprising:
said stimulus being presented to the audience externally and apart from said audience response/polling management software program such that said stimulus is not represented in any form within said audience response/polling management software program;
said audience response/polling management software program being loaded in a computer and providing an interface with a plurality of external audience response hardware devices to facilitate the flow of response data from the external audience response hardware devices into the computer so that the response data can be collected and interpreted by the audience response/polling management software program;
said audience response/polling management software program providing collection, analyzation and summarization functions of the response data which is received without being prompted by said audience response/polling management software program; and
said audience response/polling management software program permitting modification of a configuration, appearance and behavior of a real-time representation of the response data.

18. An audience response/polling management software program according to claim 17, which automatically detects and configures the interface with the external audience response hardware devices to accommodate immediate polling without requiring any intervention by an operator.

19. An audience response/polling management software program according to claim 18, wherein said real-time representation is continually and automatically updated by said audience response/polling management software program without requiring intervention by an operator.

20. An audience response/polling management software program according to claim 19, wherein said real-time representation of the response data is provided as an overlay on a corresponding display of the stimuli utilized to prompt the audience's response.
